(19) United States
(12) Patent Application Publication
(10) Pub. No.: US 2017/0220057 A1
(43) Pub. Date: Aug. 3, 2017

(54) SYSTEM FOR MITIGATING INDUCED ALTERNATING CURRENT (AC) ON PIPELINES

(71) Applicants: Stephen Jachim, Cedar Park, TX (US); Andrew Wooster, Austin, TX (US)

(72) Inventors: Stephen Jachim, Cedar Park, TX (US); Andrew Wooster, Austin, TX (US)

(73) Assignee: American Innovations, Ltd., a Texas Limited Partnership, Austin, TX (US)

(21) Appl. No.: 15/348,973

(22) Filed: Nov. 10, 2016

Related U.S. Application Data
(60) Provisional application No. 62/254,155, filed on Nov. 11, 2015.

(51) Int. Cl. G05F 1/12

(52) U.S. Cl. CPC G05F 1/12

(57) ABSTRACT

An alternating current (AC) mitigation system reduces undesired AC current induced in a pipe section by the electromagnet field of a nearby electrical utility power line. An active feedback system processes samples of the undesired AC signal from a current sensor located at the pipe section. A feedback controller generates a current compensation signal that is applied to the pipe section at a current coupler to cancel out the undesired AC signal. Corrosion of the pipe section caused by the undesired AC current may be reduced or eliminated.

### CROSS REFERENCE TO RELATED PATENT APPLICATIONS

This patent application claims priority to Provisional U.S. Patent Application Ser. No. 62/254,155, filed Nov. 11, 2015, by inventor Stephen Jachim, the disclosure of which is incorporated herein by reference in its entirety.

### BACKGROUND

The disclosures herein relate generally to pipelines situated adjacent electrical power lines, and more particularly, to the mitigation of undesired alternating current (AC) that these electrical power lines may induce in the pipelines.

### BRIEF SUMMARY

In one embodiment, a method of alternating current (AC) mitigation is disclosed that includes sensing, by a current sensor, an undesired AC current induced in a pipe section within the electromagnetic field of a high voltage utility power line, the current sensor providing an undesired current signal. The method also includes receiving, by a feedback controller, the undesired current sense signal. The method further includes generating, by the feedback controller, a current compensation signal exhibiting electrical characteristics such that the current compensation signal cancels the undesired AC current when the current compensation signal is coupled to the pipe section. The method still further includes coupling, by a current coupler located at the pipe section, the current compensation signal to the pipe section such that the current compensation signal cancels the undesired AC current.

In another embodiment, a method of alternating current (AC) mitigation is disclosed that includes sensing, by a current sensor, an undesired AC current induced in a pipe section within the magnetic field of a high voltage utility power line, the current sensor providing an undesired current signal. The method also includes receiving, by an adaptive line canceller, the current sense signal. In this embodiment, the adaptive line canceller includes a correlation processor that includes a tap weight generator that receives the current sense signal. The adaptive line canceller also includes an adjustable filter that couples to a weight output of the tap weight generator of the correlation processor, the adjustable filter exhibiting adjustable filter parameters. The adjustable filter and the tap weight generator of the correlation processor receive an AC line voltage reference signal. The method also includes correlating, by the correlation processor, the current sense signal to the AC line voltage reference signal. The method further includes adjusting, by the correlation processor, the adjustable filter parameters of the adjustable filter to minimize the correlation of the current sense signal with the AC line voltage reference signal, to provide a current compensation signal. The method still further includes supplying, by a current coupler, the current compensation signal to the pipe section to cancel the undesired current signal.

In another embodiment, a method of alternating current (AC) mitigation is disclosed that includes providing a plurality of current sensors/couplers adapted to be situated at locations along a pipe section within the magnetic field of a power line, each current sensor/coupler sensing an undesired AC current at a different location along the pipe section, each current sensor/coupler providing a respective undesired current sense signal. The method also includes providing a plurality of local feedback regulators, each local feedback regulator receiving a respective undesired current sense signal from a respective current coupler/sensor. The method further includes generating, by each of the local feedback regulators, a respective current compensation signal exhibiting electrical characteristics such that the current compensation signal cancels the undesired AC current when the respective current compensation signal is coupled to the pipe section at the respective location of each local feedback regulator, thus providing local control of undesired AC current in the pipe section.

In yet another embodiment, a method of alternating current (AC) mitigation is disclosed that includes providing a plurality of current sensors/couplers adapted to be situated at locations along a pipe section within the magnetic field of a power line, each current sensor/coupler sensing an undesired AC current at a different location along the pipe section, each current sensor/coupler providing a respective undesired current sense signal. The method also includes providing a plurality of local drivers/detectors, each driver detector of the plurality of drivers/detectors receiving a respective undesired current sense signal from a respective current coupler/sensor, the plurality of local drivers/detectors transmitting the undesired current sense signals to a Multi-in, Multi-out (MIMO) global controller as a first vector. The method further includes receiving, by the MIMO global controller, the first vector. The method still further includes manipulating, by a controller plant in the MIMO global controller, the first vector to provide a second vector that includes a plurality of current compensation signals, each current compensation signal being directed to a respective current coupler/sensor by a respective local driver/detector.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1 is a representation of a pipeline adjacent an electrical powerline.

FIG. 2 is a block diagram of one embodiment of the disclosed AC mitigation system.

FIG. 3 is a block diagram of another embodiment of the disclosed AC mitigation system.

FIG. 4 is a block diagram of yet another embodiment of the disclosed AC mitigation system that includes a distributed MIMO controller.

FIG. 5 is a block diagram of still another embodiment of the disclosed AC mitigation system that includes a global MIMO controller.

FIG. 6 is a flowchart of a least-mean-squared method that the disclosed AC mitigation system of FIG. 3 employs.

FIG. 7 is a flowchart of a MIMO state-variable control method that the disclosed AC mitigation systems of FIGS. 4 and 5 employ.

### DETAILED DESCRIPTION

In modern times, it has become increasingly common for pipelines to be deployed in the same right-of-way as high voltage electrical lines. These pipelines may include gas pipelines, oil pipelines, as well as pipelines that transport other liquid or gaseous substances. When a pipeline is deployed underground and positioned roughly parallel with a high voltage line, the high voltage line will induce undesired AC currents in the pipeline. If the pipeline exhibits a defect in its protective coating (often called a “holiday”) the induced AC current may cause corrosion of the pipeline at the location of the defect. This is of course very undesirable because it may cause failure of the pipeline at the defect's location.

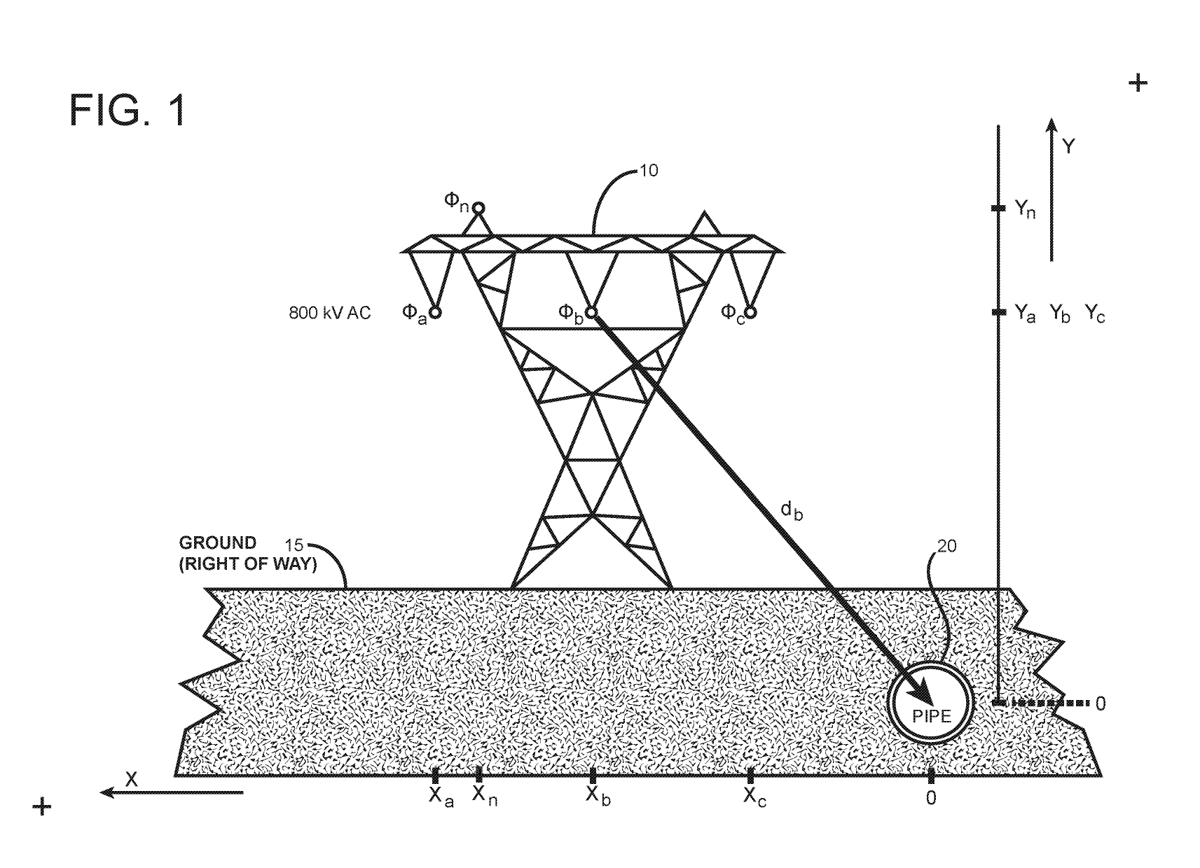

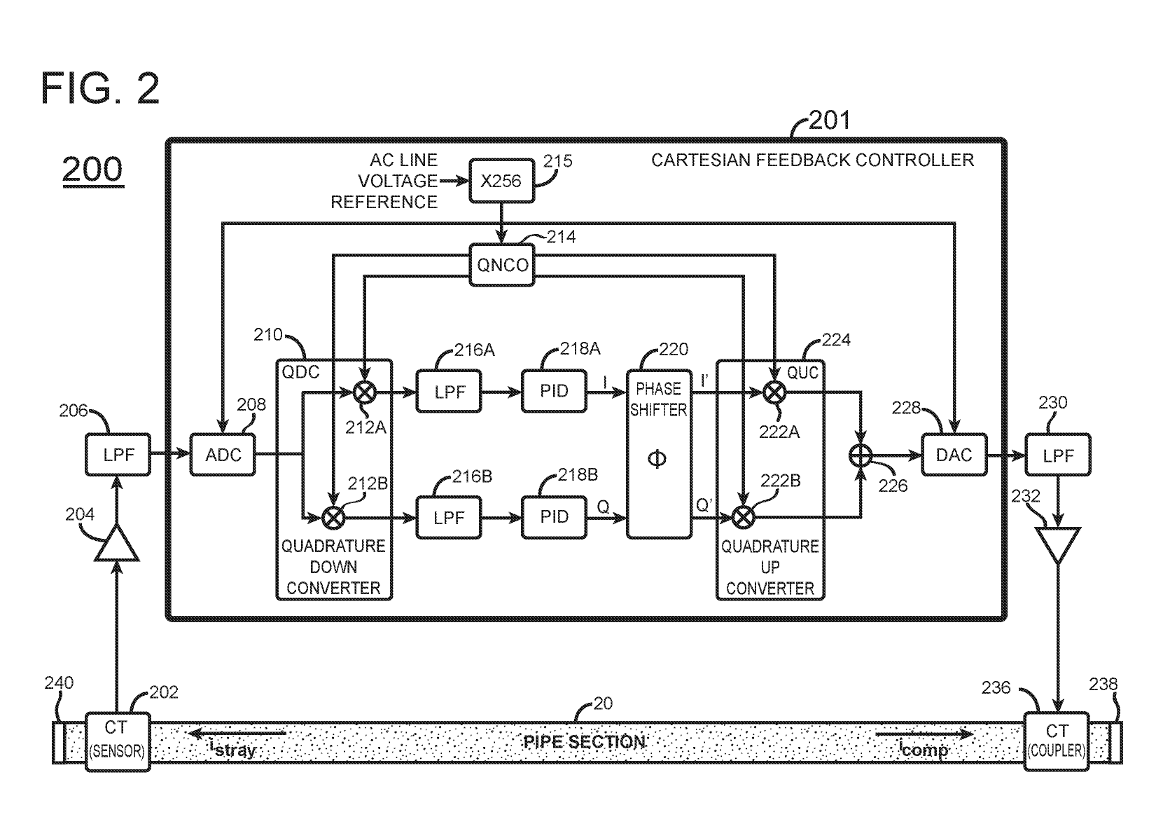

FIG. 1 is a representation of one power line tower 10 of multiple power line towers that support a high voltage electrical line, i.e. a utility power line. The high voltage power line transports alternating current (AC) from a power generation source to consumers typically via power lines strung in the air from power line tower to power line tower. Power line towers such as power line tower 10 are situated in a right-of-way on ground 15. A utility pipeline 20 is buried in ground 15 in the right-of-way as shown. Utility pipeline 20 may be fabricated of metallic material. Power line tower 20 supports a three phase electrical transmission line including phases φₐ, φ_{b}, φ_{c}, and neutral φₙ. Pipeline 20 is situated at the origin (0,0) for reference purposes. Phase φₐ is situated at (Xₐ,Yₐ). Phase φ_{b} is situated at (X_{b},Y_{b}). Phase φ_{c} is situated at (X_{c},Y_{c}). Neutral φₙ is situated at (Xₙ,Yₙ). Each of phases φₐ, φ_{b}, φ_{c} induces an AC current at the origin where pipeline 20 is located. The AC current d_{b} represents the vector sum of these 3 AC currents that combine at pipe 20 to generate an undesired AC current, that could cause corrosion in pipeline 20 if left unchecked. This undesired AC current is designated, i_{stray}, in FIG. 2 which is discussed below.

FIG. 2 is a block diagram of an AC mitigation system 200 that is configured to eliminate and/or reduce undesired AC signals otherwise induced in pipeline 20 by the high voltage electrical line formed by phases φₐ, φ_{b}, φ_{c}, and neutral φₙ. Unlike conventional passive cathodic systems that reduce corrosion due to undesired induced AC currents in a pipeline, AC mitigation system 200 provides an active solution that reduces and/or eliminates such undesired induced AC currents when they are detected by AC current sensors that monitor the pipeline. In one embodiment, AC mitigation system 200 includes a Cartesian feedback controller 201, as discussed in more detail below.

AC mitigation system 200 includes the same pipeline 20 depicted in FIG. 1 and which is subjected to the magnetic fields generated by the 3 phases φₐ, φ_{b}, φ_{c}, and neutral φₙ. These fields will tend to induce an undesired AC current, i_{stray}, in pipeline 20, as explained above. A current sensor 202 such as a current transformer (CT) is located at a sensing location on pipeline 202. Current sensor 202 may be situated on or adjacent to pipeline 202 at the sensing location. In either case, current sensor 202 should be sufficiently close to pipeline 202 to enable current sensor to sense the undesired AC current, i_{stray}, in pipeline 20, at the sensing location. A toroidal current sensor wound around the circumference of pipeline 20 at the sensing location is an example of one current sensor that has been found to produce acceptable AC current sensing results. Although not specifically shown in FIG. 2, current sensor 202 of AC mitigation system 200 is located underground and adjacent pipeline 20.

The output of current sensor 202 couples via amplifier 204 and low pass filter (LPF) 206 to the input of an analog to digital converter (ADC) 208 that forms part of Cartesian feedback controller 201, as shown in FIG. 2. Amplifier 204 increases the amplitude of the current sense signal that current sensor 202 senses for the undesired AC current, i_{stray}. LPF 206 band limits the amplified current sense signal.

Controller 201 includes a quadrature down converter (QDC) 210. The output of ADC 208 couples to the input of quadrature down converter (QDC) 210 to provide the amplified, band-limited digital current sense signal to QDC 210. Quadrature down converter 210 includes multipliers 212A and 212B that separate the digital current sense signal into in-phase and quadrature components, respectively. To achieve this down-conversion, controller 201 includes a quadrature numerically controller oscillator (QNCO) 214 that supplies sine and cosine signals to multipliers 212A and 212B, respectively. QNCO 214 couples to an ×256 multiplier block 215, the input of which is coupled to an AC line reference voltage that itself is coupled to an AC line voltage reference, as shown. ×256 multiplier block 215 is a frequency multiplier that takes an input signal and multiplies the input signal by 256 to provide an output signal. In one embodiment, multiplier 256 takes a 60 Hz input signal and multiplies that input signal by 256 to provide an output signal that it sends to QNCO 214. QNCO effectively acts as two local oscillators. Multipliers 212A and 212B effectively move the digital current sense signal from ADC 208 down to baseband, i.e. zero frequency. In this manner, multipliers 212A and 212B extract the in-phase and quadrature components of the digital current sense signal (the AC signal).

Multipliers 212A and 212B couple to low pass filters (LPFs) 216A, 216B, respectively that band limit the in-phase and quadrature signals passing therethrough. LPFs 216A and 216B couple to proportional-integral-differential compensators (PIDs) 218A and 218B, respectively. PIDs 218A and 218B provide feedback gain to the in-phase signal (I) and the quadrature signal (Q) that appear at the outputs of PIDs 218A and 218B, respectively. The outputs of PIDs 218A and 218B couple to respective inputs of a phase shifter (φ) 220, as shown. Phase shifter (φ) 220 takes the I and Q signals (i.e. vectors) and transforms those vectors to another vector at a different angle while still maintaining the 90-degree relationship between the two vectors. The phase-shifted vectors are designated I′ and Q′ at the respective outputs of phase shifter 220, as shown. Phase shifter 220 operates in accordance with Equation 1 below:

$$\begin{matrix}[ \begin{matrix}{I}^{′} \\ {Q}^{′}\end{matrix} ] = [ \begin{matrix}cos φ & - sin φ \\ sin φ & cos φ\end{matrix} ] [ \begin{matrix}I \\ Q\end{matrix} ] = φ [ \begin{matrix}I \\ Q\end{matrix} ] & EQUATION 1 \\ wherein φ = & \\ [ \begin{matrix}cos φ & - sin φ \\ sin φ & cos φ\end{matrix} ] & \end{matrix}$$

Phase shifter 220 effectively multiplies the input vector [I, Q] by the transformation block matrix [cos θ, −sin θ, sin θ, cos θ] to generate the output vector [I′, Q′]. Adjusting the values of the transformation block matrix enables phase shifter 220 to adjust the angle of the output vector [I′, Q′]. The purpose of phase shifter 220 is to adjust the loop phase around the feedback loop formed by controller 201, current sensor 202, pipe section 20, and current coupler 236. The phase of phase shifter 220 is adjusted so that the resultant current compensation signal, i_{comp}, supplied by controller 201 to current coupler 238 will enable the compensation signal, i_{comp}, to cancel out the undesired AC signal, i_{stray}. Those skilled in the art will appreciate that the values of the 4 elements of transformation block matrix may be determined analytically or experimentally depending on the particular application.

Controller 201 supplies the output vector [I′, Q′] to a quadrature up converter (QUC) 224 that includes mixers (i.e. multipliers) 222A and 222B. Mixers 222A and 222B of quadrature up converter 224 are coupled to quadrature numerically controller oscillator (QNCO) 214 so that mixers 222A and 222B respectively receive the same sine and cosine signals that were applied to quadrature up converter 210. The outputs of mixers 222A and 222B are coupled to an adder (summer) 226 that combines the up-converted I′ and Q′ signals into a composite signal. The composite signal is applied to a digital to analog converter (DAC) 228 to provide an analog output signal. DAC 228 couples to a low pass filter LPF 230 so that the analog output signal is applied to LPF 230. LPF 230 reconstructs the analog output signal to provide a reconstructed analog output signal that amplifier 232 amplifies to provide a AC current compensation signal, i_{comp}. Amplifier 232 is coupled to a current transformer 236 that is situated on pipe section 20, as shown in FIG. 2. Current transformer 236 acts as a current coupler that supplies the compensation current, i_{comp}, to pipe section 20 so that the undesired AC current i_{stray} is substantially reduced in amplitude or cancelled out. With the undesired AC current reduced in amplitude in this manner, the likelihood of corrosion of pipe section 20 is substantially reduced.

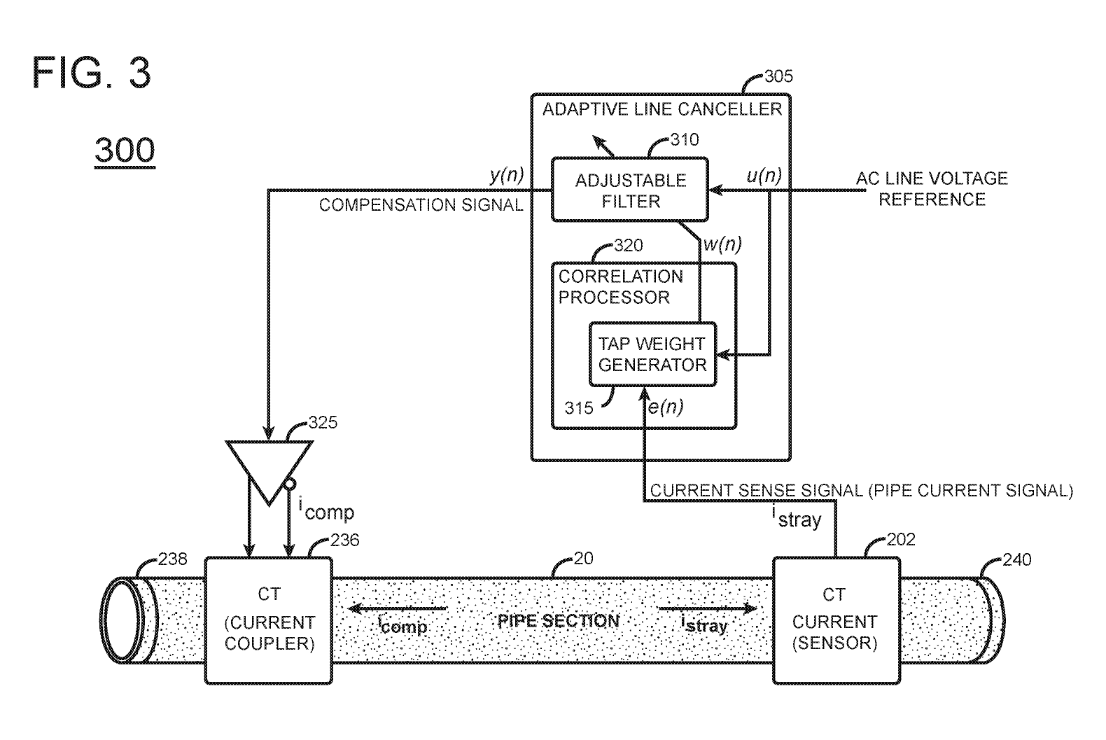

FIG. 3 shows a block diagram of another embodiment of the disclosed AC mitigation system as AC mitigation system 300. Like AC mitigation system 200, AC mitigation system 300 is configured to eliminate and/or reduce undesired AC signals otherwise induced in pipeline section 20 by the high voltage electrical line formed by phases φₐ, φ_{b}, φ_{c}, and neutral φₙ. System 300 includes a number of elements in common with system 200. Like numbers indicate like elements when comparing system 300 with system 200. For example, current sensor 202, current coupler 236, pipe section 20, insulative pipe joint 238 and insulative pipe joint 240 are common to both systems.

AC mitigation system 300 employs current sensor 202 to sense the undesired AC signal, i_{stray}, that overhead high voltage electrical lines induce in pipe section 20. Current sensor 202 couples to a correlation processor 320 in an adaptive line canceller. Adaptive line canceller 305 includes an adjustable filter 310, the output of which is coupled to current coupler 236. In one embodiment, amplifier 325 includes a differential output, as shown in FIG. 3. As discussed in more detail below, adaptive line canceller 305 receives the undesired AC signal, i_{stray}, from current sensor 202 and processes this signal in a manner such that adaptive line canceller 205, in cooperation with amplifier 325, sends an AC compensation signal, i_{comp}, through current coupler 236 to cancel out the undesired AC signal, i_{stray}. The sensed undesired AC signal, i_{stray}, may also be referred to as the pipe current signal. In this embodiment, pipe section 20 itself forms part of a feedback loop that includes current sensor 202, adaptive line canceller 305, amplifier 325 and current coupler 236.

Correlation processor 320 includes a tap weight generator 315. An AC line voltage signal, u(n), is supplied to respective inputs of tap weight generator 315 and adjustable filter 310, is shown. The AC line voltage signal is taken from the power grid and consequently will be highly correlated with the undesired AC signal at the location of current sensor 202 on pipe section 20. In one embodiment, controller 201 acts to effectively decorrelate the undesired AC signal on pipe section 20 with the i_{comp} signal to be coupled to the pipe section 20 to cancel the undesired AC signal. Stated alternatively, controller 201 acts to decorrelate the i_{comp} signal with the undesired i_{stray} signal. The output of tap weight generator 320 couples to adjustable filter 310. In this manner, tap weight generator 315 of correlation processor 320 provides a weighted signal, w(n), to adjustable filter 310. The current sense signal, e(n), from current sensor 202 is provided to tap weight generator 315, as shown in FIG. 3. Correlation processor 320 correlates the current sense signal, e(n), to the AC line voltage reference signal. The correlation processor employs a method, discussed below, that adjusts the filter parameters of adjustable filter 310 to minimize the correlation of the current sense signal, e(n), to the AC line voltage reference signal. The output signal of adjustable filter 310 is designated y(n) and is supplied to the input of differential output amplifier 325. When amplified by amplifier 325, the compensation signal y(n) generated at the output of adjustable filter 310 becomes the i_{comp} AC signal that current coupler 236 transfers to pipe section 20 to effectively cancel out or reduce the amplitude of the undesired AC i_{stray} signal.

In this embodiment, pipe section 20 itself forms part of a feedback loop that includes current sensor 202, adaptive line canceller 305, amplifier 325 and current coupler 236. In this embodiment, correlation processor 320 may employ an adaptive least means squared (LMS) method, namely a gradient method, to generate tap weights that are supplied to adjustable filter 310 to adjust the filter parameters of adjustable filter 310 to minimize the correlation of the current sense signal e(n) to the AC line voltage reference. In this manner, adaptive line canceller 205 supplies a compensation signal, i_{comp}, that cancels the undesired AC signal, i_{stray}, in pipe section 20. System 300 is adaptive because it responds and adjusts the parameters of adjustable filter 310 as the induced undesired AC signal, i_{stray}, changes in pipe section 20.

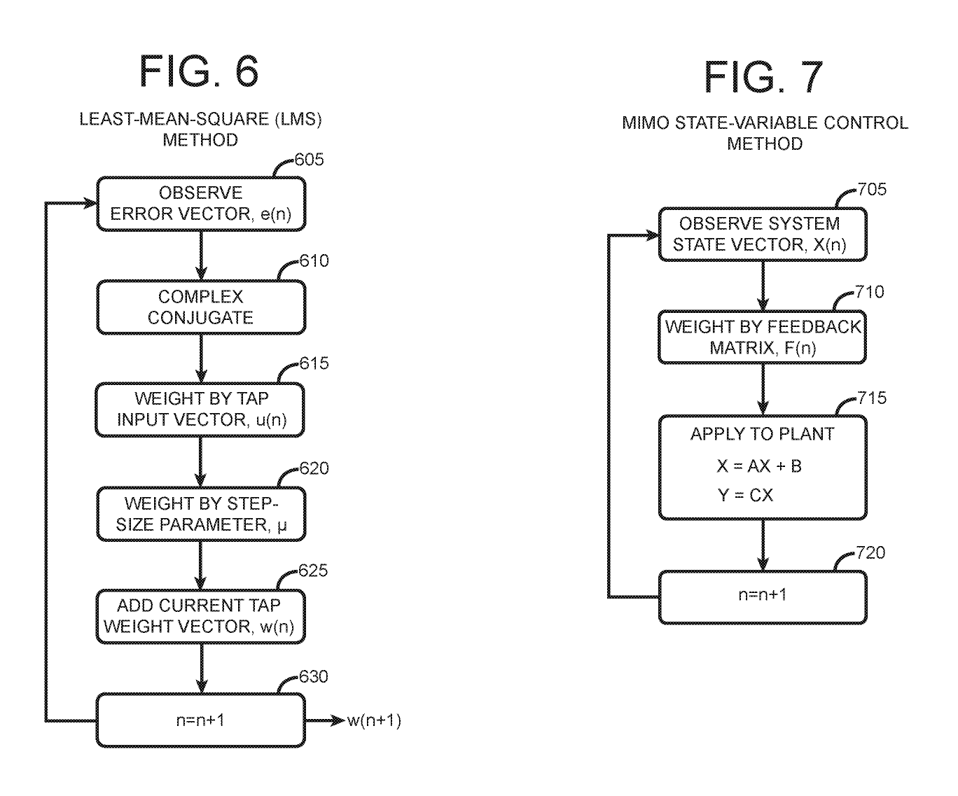

The least means squared (LMS) method that correlation processor 320 may employ is depicted in the flowchart of FIG. 6. Correlation processor 320 receives and observes the current sense signal e(n) from current sensor 202 on pipe section 20, as per block 605. The current senses signal e(n) is also referred to as error vector, e(n). Correlation processor 320 determines the complex conjugate of error vector, e(n), as per block 610. Correlation processor 610 determines appropriate weights by multiplication with the input vector, u(n), which represents the AC line voltage reference signal, as per block 615. Correlation processor 320 performs weighting by step-size parameter, μ, as per block 620. The step size parameter, μ, is a scalar multiple that multiplies the output of the previous stage. It provides a gain factor in the adaptive process that adaptive line canceller 305 provides.

Correlation processor 320 adds the current tap weight vector, w(n), as per block 625. This provides an adjustment to the tap weight vector each time correlation processor 320 goes around the loop formed by blocks 605, 610, 615, 620, 625 and 630. Correlation processor 320 increments by 1 at block 630 (i.e. n=n+1). In block 630, correlation processor 630 outputs weight w(n−1) which is sent to adjustable filter 310 to adjust the parameters of adjustable filter 310 in accordance with the weighting directed by weight w(n−1). In block 630, process flow continues back to observe error vector, e(n) at which processor observes the next current sense signal from current sensor 202. The above described method then repeats. In this manner, adaptive line canceller adapts 305 to changing observed undesired AC signals from pipe section 20 over time to always supply a current compensation signal i_{comp} to pipe section 20 that reduces or substantially cancels out in real time the presently observed undesired AC current in the pipe section 20.

It is noted that in Cartesian feedback controller 201 a first channel includes multiplier 2121A of QUC 210, LPF 216A, PID 218A, phase shifter 220 and multiplier 222A of QUC 224. A second channel includes multiplier 2121B of QUC 210, LPF 216B, PID 218B, phase shifter 220 and multiplier 222B of QUC 224

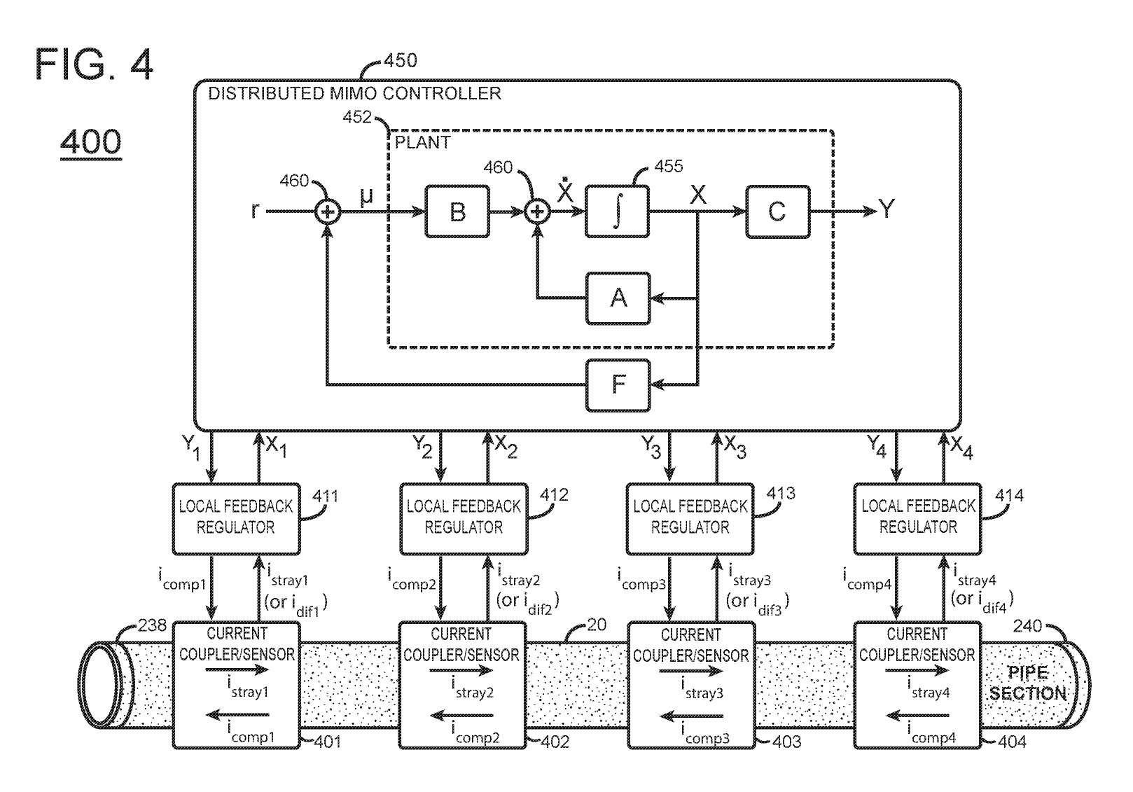

FIG. 4 is a block diagram of one embodiment of the disclosed AC mitigation system 400 that includes a distributed MIMO (Multi-In, Multi-Out) controller 450 that substantially reduces or eliminates undesired AC signals induced in pipe section 20 by adjacent high voltage electrical lines. Multiple current couplers/sensors such as current couplers/sensors 401, 402, 403 and 404 are distributed at different locations along pipe section 20. In one embodiment, pipe section 20 may be in the range of approximately 1 km to approximately 5 km in length, although the system may be deployed on shorter length and longer length pipe sections as well.

Each of current couplers/sensors 401-404 includes a current sensor and a current coupler. The current sensor of these current couplers/sensors may be the same as current sensor 202 discussed above with reference to FIG. 2. In one embodiment, the current sensor 202 and current coupler 236 of FIG. 2 taken together form a representative current coupler/sensor 401 of FIG. 4. Likewise, each of the remaining current couplers/sensors 402, 403 and 404 of FIG. 4 are formed by packaging current sensor 202 and current coupler 236 together to form current couplers/sensors. In one embodiment, the current sensor and current coupler are collocated on pipe section 20 to form a particular current coupler/sensor. Each of current couplers/sensors 401, 402, 403 and 404 may be formed in this manner.

While each of current couplers/sensors 401-404 of FIG. 4 is formed by the combination of a current sensor 202 and a current coupler 236, each of local feedback regulators 411 of FIG. 4 is formed by a combination of Cartesian feedback controller 201 of FIG. 2 together with amplifier 204, LPF 206, LPF 230, amplifier 232 and load 234 of FIG. 2.

As discussed above, current couplers/sensors 401-404 include current sense outputs i_{stray1}, i_{stray2}, i_{stray3}, and i_{stray4}, respectively, that transmit the current sense signals to corresponding inputs of local feedback regulators 411, 412, 413, and 414, respectively, as shown in FIG. 4. Current couplers/sensors 401-404 may be alternatively referred to as current coupler/sensor nodes.

The current sensor of each of the current couplers/sensors 401-404 is now discussed. Taking current coupler/sensor 401 as being representative, the current sensor within current coupler/sensor 401 senses the AC signal, e.g. i_{stray1}, that nearby high voltage lines induce in pipe section 20 at the location of this particular current coupler/sensor 401. The current sensor of each of these current couplers/sensors may be the same as current sensor 236 discussed above.

The current coupler of each of current couplers/sensor 401-404 of FIG. 4 may be the same as current coupler (i.e. actuator) 236 of FIG. 2. The current coupler of a particular coupler/sensor such as 401 couples the AC compensation signal (e.g. i_{comp1}) from Cartesian feedback controller 201 to pipe section 20. In this manner, the AC compensation signal i_{comp1} supplied by local feedback regulator 411 is applied by current coupler/sensor 401 to pipe section 20 such that the AC compensation signal i_{comp1} cancels or substantially cancels the undesired AC signal i_{stray1} sensed at the location of the particular coupler/sensor 401. In one embodiment, pipe section 20 is attached to other pipe sections via insulative pipe joints 238 and 240 at its opposed ends. Insulative pipe joints 238 and 240 provide mechanical connection of pipe section 20 to adjacent pipe sections while keeping pipe section 20 electrically insulated from adjacent pipe sections.

As discussed above, representative local feedback regulator 411 receives the sensed current i_{stray1} signal from current coupler/sensor 401. Local feedback regulator 411 uses this i_{stray1} signal to determine and generate an i_{comp1} signal that cancels out the i_{stray1} signal when the i_{comp1} signal is coupled to the pipe section 20 by current coupler/sensor 401. In one embodiment, in actual practice instead of current sensor 401 providing the i_{stray1} signal to local feedback regulator 411, current coupler/sensor 401 may provide an i_{dif1} signal to current regulator 411, wherein i_{dif1} is the difference between the i_{stray1} and i_{stray2} signal. Local feedback regulator 411 then uses the i_{dif1} signal to determine and generate a current compensation signal i_{comp1} that cancels out the undesired istray1 signal in pipe section 20 where current coupler/sensor 401 is located.

While each of local feedback regulators 411-414 can individually control undesired AC current local to these regulators, distributed MIMO controller 450 may exert another layer of overall control on top of the individual control provided by local feedback regulators 411-414. The control offered by the individual local feedback regulators 411-414 may be referred to as “local control”, while the overall control provided by distributed MIMO controller 450 to the local feedback regulators 411-414 may be referred to as “overall control”.

The overall control that distributed MIMO controller 450 provides to local feedback regulators 411-415 and current couplers/sensors 401-404 is now discussed. Local feedback regulators 411-414 provide a vector X to distributed MIMO controller 450, wherein X is a state vector that includes the elements X₁, X₂, X₃ and X₄ that local feedback regulators 411 generate at their respective outputs. Within the X vector, X₁ is a variable that is an analog, i.e. replica, of the vector sum of i_{stray1} and i_{comp1}. Similarly, X₂ is an analog of the vector sum of i_{stray2} and i_{comp2}, X₃ is an analog of the vector sum of i_{stray3} and i_{comp3}, and X₄ is in analog of the vector sum of i_{stray4} and i_{comp4}. The icomp1 variable is an amplified analog of the Y₁ signal, the i_{comp2} variable is an amplified analog of the Y₂ signal, the i_{comp3} variable is an amplified analog of the Y₃ signal, and the i_{comp4} variable is an amplified analog of the Y₄ signal.

Within distributed MIMO controller 450, there is a state-variable model of the controlled plant 452, the operation of plant 452 being governed by the controller EQUATION 2 below:

\dot{X}=AX+B

Y=CX+ [symbol] ⁰ EQUATION 2

“\dot{X}” is the differential of the X vector that local feedback regulators 411-414 provide to distributed MIMO controller 450. Local feedback regulators 411 transmit the X vector to the locus X shown symbolically in distributed MIMO controller 450 of FIG. 4. Within controller 450, the values A, B and C are constants determined analytically or experimentally. F represents feedback. Y is the output state vector from plant 452. The Y vector includes the Y₁, Y₂, Y₃ and Y₄ values that distributed MIMO controller supplies to local feedback regulators 411, 412, 413 and 414, respectively. A reference voltage “r” is supplied by a source to a first input of adder 460. Reference voltage “r” is a reference signal for this control system. In one embodiment, reference voltage “r” may be set to zero or another constant value. The feedback F is supplied to a second input of adder 460. In plant 452, the output of B and the output of A couple to respective inputs of adder 460 that adds A and B together and supplies the result as “\dot{X}” to integrator 455. As stated above, “\dot{X}” is the differential of the X, i.e. the differential of the X vector which is a state vector. In this controller configuration, “μ” represents the error signal. In one embodiment, the parameter values A, B and C can be analytically calculated or determined by system identification. These parameters describe the dynamic behavior of the plant 452.

Turning momentarily to FIG. 7, a MIMO state-variable control method is described wherein the plant model {A, B, C} corresponds to the open-loop dynamics of each coupler/sensor node. The method includes observing the system state vector, X(n) wherein n varies for 1 to 4, as per block 705. The feedback matrix, F(n) weights the state vector X(n), as per block 710). The weighted values are applied to the plant defined by EQUATION 2 above, as per block 715. Next, the method increments n by 1, as per block 720, and the process continues in real time. Plant 452 operates by acting to regulate the state vector X(n). In one embodiment, Y₁ becomes the reference signal for local feedback regulator 411. Thus, the output of one control system (i.e. MIMO controller 450) becomes the reference level for another control system (i.e. local feedback regulator 411.) Y₂, Y₃, Y₄ behave similarly with respect to local feedback regulators 412, 423 and 414. In this manner local feedback regulators 411-414 provide local control of the undesired AC signal at locations on pipe section 240 where they are installed, while distributed MIMO controller 450 provides overall control of the undesired AC signals along pipe section 20.

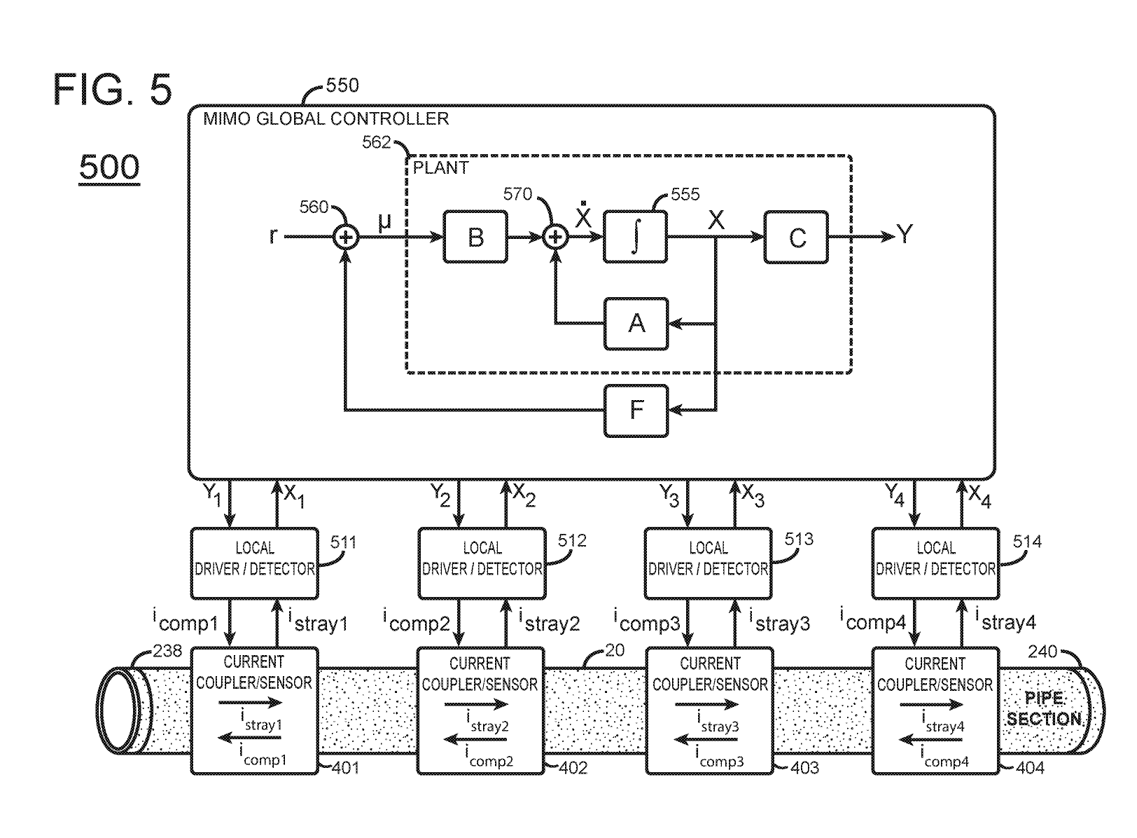

FIG. 5 is a block diagram of another embodiment of the disclosed AC mitigation system 500 that includes a (Multi-Input, Multi-Output) global controller 550 that substantially reduces or eliminates undesired AC signals induced in pipe section 20 by adjacent high voltage electrical lines. AC mitigation system 500 of FIG. 5 includes a number of components in common with AC mitigation system 400 of FIG. 4. Like numbers are used to indicate like components when comparing the system of FIG. 5 with the system of FIG. 4.

For example, AC mitigation system 500 employs the same current couplers/sensors 401-414 that AC mitigation system 400 employs. However, in contrast to AC mitigation system 400 of FIG. 4, AC mitigation system 500 includes local driver/current detectors 511-514 that act as pass-through buffers in one embodiment. Local driver/detector 511 is representative of local current driver/detectors 511-514 and is now discussed. Local driver/detector 511 includes both detector and a driver. The detector of local driver/detector 511 receives the i_{stray1} current sense signal and amplifies the i_{stray1} current sense signal to a level sufficient to supply to MIMO global controller 550. The detector of local driver/detector 511 supplies the amplified, i.e. buffered, i_{stray1} signal to MIMO global controller 550 as X₁, namely part of the X vector that local driver/detectors 511-514 supply to the plant 562 of MIMO global controller 550. The detectors of remaining local drivers/detectors 511-512 similarly supply the remaining part of the X vector, namely X₂, X₃ and X₄, to the plant 562 of MIMO global controller 550.

Local driver/detector 511 further includes a driver that provides amplification to the Y1 value of the output vector, Y, that plant 562 generates in response to a particular X vector received from local drivers/detectors 511-514. The driver of representative local driver/detector 511 amplifies the Y1 signal up to a level sufficient to drive current coupler/sensor 401 as the compensation current i_{comp1} that cancels out the undesired i_{stray1} current at current coupler/sensor 401. It is noted that in one embodiment, the i_{stray1} current cancels out the undesired i_{stray1} current in real time. In other words, current couplers/sensors 401-411 sense respective i_{stray} currents in pipe section 20 in real time, plant 562 processes the resultant X vectors (X₁, X₂, X₃ and X₄) it receives in real time, and plant 562, using a responsive output Y vector (Y₁, Y₂, Y₃ and Y₄) instructs current couplers/suppressors 401-414, respectively, in real time with the present i_{comp} values (i_{comp1}−i_{comp4}) to couple to the pipe section 20 to cancel the undesired i_{stray} signals (i_{comp1}−i_{comp4}). Employing local drivers/detectors in this manner, i.e. driver/detectors that are situated at the pipe section avoids the need to maintain high current Y vector signals from the MIMO global controller 500 to the current coupler/sensors located at the pipe section 20.

MIMO global controller 550 of FIG. 5 exhibits a configuration similar to distributed MIMO 450 of FIG. 4, however, plant 562 is different from plant 462 in that constants A, B, C and F exhibit different values in this embodiment. Components 560 and 570 represent adders, i.e. summers, in this configuration. A, B and C are determined using the approach described above. F is a feedback factor, namely a set of parameters determined by an appropriate feedback control design algorithm that is one of the many that are readily available. Components 560 and 570 represent adders, i.e. summers, in this configuration.

In this manner, MIMO global controller 550 of FIG. 5 mitigates the undesired AC signal i_{comp} in pipe section 20 by coupling different i_{comp} currents (i_{comp1}−i_{comp4}) to pipeline section 20 at different coupler/sensor locations along its length.

In one embodiment, distributed MIMO controller 450 of FIG. 4 and global MIMO controller 550 of FIG. 5 may be implemented in hardware or firmware. Alternatively, distributed MIMO controller 450 and global MIMO controller 550 may be stored and executed on an information handling system (IHS) such as a server including a processor, memory, drive storage and networking capability to connect to current couplers/sensors on the pipeline. In this manner, distributed MIMO controller 450 and global MIMO controller 550 may be located remotely with respect to the pipe section 20 as long as communication capability is provided between the controller 450 and the local feedback regulators, or between the controller and the local driver/detector. In one embodiment, the term local means adjacent to, located at, or located near the pipeline. In comparing AC mitigation system 500 of FIG. 5 with AC mitigation system 400 of FIG. 4, it is noted that in AC mitigation system 500, all of the control functions are contained within MIMO global controller 500, whereas in AC mitigation system 400 the control functions are split between distributed MIMO controller 450 and local feedback regulators 411-414. It is noted that all embodiment may operate in real time to cancel undesired AC signals on pipe section 20.

Turning now to FIG. 7, a MIMO state-variable control method is described. However, as applied to AC mitigation system 500 of FIG. 5, the plant model {A, B, C} corresponds to the closed-loop dynamics of each coupler/sensor node. The method includes observing the system state vector, X(n) wherein n varies for 1 to 4, as per block 705. Block 710 provides weight by feedback matrix, F(n). The weighted values are applied to the plant defined by EQUATION 2 above, as per block 715. Next, the method increments n by 1, as per block 720, and the process continues in real time.

In summary, an alternating current (AC) mitigation system is disclosed that includes a current sensor that senses an undesired AC current induced in a pipe section within the electromagnetic field of a high voltage utility power line, the current sensor providing an undesired current signal. The AC mitigation system also includes a feedback controller, coupled to the current sensor, that receives the undesired current sense signal, wherein the feedback controller generates a current compensation signal exhibiting electrical characteristics such that the current compensation signal cancels the undesired AC current when the current compensation signal is coupled to the pipe section. The AC mitigation system also includes a current coupler, located at the pipe section, that couples the current compensation signal to the pipe section such that the current compensation signal cancels the undesired AC current. In one embodiment, the feedback controller of the (AC) mitigation system is a Cartesian feedback controller. In one embodiment, the current compensation signal exhibits the same frequency as the undesired AC current. In another embodiment, the current compensation signal exhibits the same amplitude as the undesired AC current. In yet another embodiment, the current compensation signal is 180 degrees out of phase with respect to the undesired AC current.

In summary, in another embodiment, an alternating current (AC) mitigation system is disclosed that includes a current sensor that senses an undesired AC current induced in a pipe section within the electromagnetic field of a high voltage utility power line, the current sensor providing an undesired current signal. The AC mitigation system also includes an adaptive line canceller, coupled to the current sensor, that receives the current sense signal. The adaptive line canceller includes a correlation processor that includes a tap weight generator that receives the current sense signal. The adaptive line canceller also includes an adjustable filter that couples to a weight output of the tap weight generator of the correlation processor, the adjustable filter exhibiting adjustable filter parameters. The adjustable filter and the tap weight generator of the correlation processor receive an AC line voltage reference signal. The correlation processor correlates the current sense signal to the AC line voltage reference signal. The correlation processor adjusts the adjustable filter parameters of the adjustable filter to minimize the correlation of the current sense signal with the AC line voltage reference signal, to provide a current compensation signal. The AC mitigation system also includes a current coupler, coupled to the adaptive line canceller, that couples the current compensation signal to the pipe section to cancel the undesired current signal. In one embodiment, the pipe section forms part of a feedback loop that includes the current sensor, the adaptive line canceller and current coupler. In another embodiment, the correlation processor employs a least means squared (LMS) method to generate tap weights that correlation processor supplies to the adjustable filter to adjust the parameters of the adjustable filter to minimize the correlation of the current sense signal to the AC line voltage reference. In yet another embodiment, the correlation processor adaptively adjusts the parameters of the adjustable filter as the induced undesired AC signal changes in the pipe section.

In summary, in yet another embodiment, an alternating current (AC) mitigation system is disclosed that includes a plurality of current sensors/couplers adapted to be situated at locations along a pipe section within the electromagnetic field of a power line, each current sensor/coupler sensing an undesired AC current at a different location along the pipe section, each current sensor/coupler providing a respective undesired current sense signal. The AC mitigation system also includes a plurality of local feedback regulators, each local feedback regulator being coupled to a respective current sensor/coupler, each local feedback regulator receiving a respective undesired current sense signal from a respective current coupler/sensor. Each of the local feedback regulators generates a respective current compensation signal exhibiting electrical characteristics such that the respective current compensation signal cancels the undesired AC current when the respective current compensation signal is coupled to the pipe section at the respective location of each local feedback regulator, thus providing local control of undesired AC current in the pipe section. In one embodiment, the plurality of local feedback regulators are Cartesian controllers. In another embodiment, the AC mitigation system also includes a distributed Multi-in, Multi-out (MIMO) controller that is coupled to the plurality of local feedback regulators to provide overall control of the plurality of local feedback regulators. In yet another embodiment, the distributed MIMO controller receives a first vector that includes undesired current information from each of the local feedback regulators of the plurality of local feedback regulators. In still another embodiment, the distributed MIMO controller includes a controller plant that generates a second vector that includes current compensation information for each of the local feedback regulators of the plurality of local feedback regulators, the distributed MIMO controller providing overall control of the plurality of local feedback regulators.

In summary, in still another embodiment, an alternating current (AC) mitigation system is disclosed that includes a plurality of current sensors/couplers adapted to be situated at locations along a pipe section within the electromagnetic field of a power line, each current sensor/coupler sensing an undesired AC current at a different location along the pipe section, each current sensor/coupler providing a respective undesired current sense signal. The AC mitigation system also includes a plurality of local drivers/detectors coupled to the plurality of current sensors/couplers, wherein each driver detector of the plurality of drivers/detectors receiving a respective undesired current sense signal from a respective current coupler/sensor. The disclosed AC mitigation system also includes a Multi-In, Multi-Out (MIMO) global controller, coupled to the plurality of local drivers/detectors, that receives a first vector that represents the undesired current sense signals from the plurality of local drivers/detectors. In this embodiment, the MIMO global controller includes a controller plant that manipulates the first vector to provide a second vector that includes a plurality of current compensation signals, each current compensation signal being directed to a respective current coupler/sensor by a respective local driver/detector. In one embodiment of the AC mitigation system, the plurality of local drivers/sensors includes respective driver amplifiers, wherein the respective driver amplifiers amplify the respective current compensation signals of the second vector to provide amplified current compensation signals to respective current couplers in the plurality of current sensors/couplers along the pipe section. In another embodiment of the AC mitigation system, the plurality of local drivers/sensors includes respective detectors in each of the local driver/sensors, wherein the respective detectors buffer respective undesired current sense signals to form the first vector that the MIMO global controller receives from the plurality of local drivers/detectors. In yet another embodiment of the AC mitigation system, the MIMO global controller provides overall control of the transmission of current compensation signals to the current couplers of the plurality of current couplers/sensors by the local drivers/detectors of the plurality of local drivers/detectors. In still another embodiment of the AC mitigation system, the MIMO global controller operates in real time to process the first vector and generate the second vector to cancel the undesired AC signal on the pipe section.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of alternating current (AC) mitigation, comprising:
sensing, by a current sensor, an undesired AC current induced in a pipe section within the electromagnetic field of a high voltage utility power line, the current sensor providing an undesired current signal;
receiving, by a feedback controller, the undesired current sense signal;
generating, by the feedback controller, a current compensation signal exhibiting electrical characteristics such that the current compensation signal cancels the undesired AC current when the current compensation signal is coupled to the pipe section; and
coupling, by a current coupler located at the pipe section, the current compensation signal to the pipe section such that the current compensation signal cancels the undesired AC current.

2. The method of claim 1, wherein the feedback controller is a Cartesian feedback controller.

3. The method of claim 1, wherein the current compensation signal exhibits the same frequency as the undesired AC current

4. The method of claim 1, wherein the current compensation signal exhibits the same amplitude as the undesired AC current.

5. The method of claim 1, wherein the current compensation signal is 180 degrees out of phase with respect to the undesired AC current.

6. The method of claim 2, wherein the current sense signal is an analog current sense signal, the method further comprising:
sampling, by an analog to digital converter (ADC) the analog current sense signal to provide a digital current sense signal;
down-converting, by a quadrature down converter (QDC), the digital current sense signal into in-phase and quadrature components;
phase shifting, by a phase shifter the in-phase and quadrature components to provide phase shifted in-phase and quadrature components;
up-converting, by a quadrature up converter (QUC), the phase shifted in-phase and quadrature components that are combined in an adder to provide an up-converted signal;
converting, by a digital to analog converter (DAC), the up-converted signal to an analog signal that provides the current compensation signal.

7. A method of alternating current (AC) mitigation, comprising:
sensing, by a current sensor, an undesired AC current induced in a pipe section within the electromagnetic field of a high voltage utility power line, the current sensor providing an undesired current signal;
receiving, by an adaptive line canceller, the current sense signal, the adaptive line canceller including:
a correlation processor that includes a tap weight generator that receives the current sense signal;
an adjustable filter that couples to a weight output of the tap weight generator of the correlation processor, the adjustable filter exhibiting adjustable filter parameters;
wherein the adjustable filter and the tap weight generator of the correlation processor receive an AC line voltage reference signal;
correlating, by the correlation processor, the current sense signal to the AC line voltage reference signal;
adjusting, by the correlation processor, the adjustable filter parameters of the adjustable filter to minimize the correlation of the current sense signal with the AC line voltage reference signal, to provide a current compensation signal; and
supplying, by a current coupler, the current compensation signal to the pipe section to cancel the undesired current signal.

8. The method of claim 7, wherein the pipe section forms part of a feedback loop that includes the current sensor, the adaptive line canceller and current coupler.

9. The method of claim 7, wherein the correlation processor employs a least means squared (LMS) method to generate tap weights that correlation processor supplies to the adjustable filter to adjust the parameters of the adjustable filter to minimize the correlation of the current sense signal to the AC line voltage reference.

10. The method of claim 7, wherein the method adaptively adjusts the parameters of the adjustable filter as the induced undesired AC signal changes in the pipe section.

11. A method of alternating current (AC) mitigation, comprising:
providing a plurality of current sensors/couplers adapted to be situated at locations along a pipe section within the electromagnetic field of a power line, each current sensor/coupler sensing an undesired AC current at a different location along the pipe section, each current sensor/coupler providing a respective undesired current sense signal;
providing a plurality of local feedback regulators, each local feedback regulator receiving a respective undesired current sense signal from a respective current coupler/sensor, and
generating, by each of the local feedback regulators, a respective current compensation signal exhibiting electrical characteristics such that the current compensation signal cancels the undesired AC current when the respective current compensation signal is coupled to the pipe section at the respective location of each local feedback regulator, thus providing local control of undesired AC current in the pipe section.

12. The method of claim 11, wherein the plurality of local feedback regulators are Cartesian controllers.

13. The method of claim 11, further comprising:
providing a distributed Multi-in, Multi-out (MIMO) controller that provides overall control of the plurality of local feedback regulators.

14. The method of claim 13, further comprising:
receiving, by the distributed MIMO controller, a first vector that includes undesired current information from each of the local feedback regulators of the plurality of local feedback regulators.

15. The method of claim 14, further comprising:
generating, by a controller plant of the distributed MIMO controller, a second vector that includes current compensation information for each of the local feedback regulators of the plurality of local feedback regulators, the distributed MIMO controller providing overall control of the plurality of local feedback regulators.

16. A method of alternating current (AC) mitigation, comprising:
providing a plurality of current sensors/couplers adapted to be situated at locations along a pipe section within the electromagnetic field of a power line, each current sensor/coupler sensing an undesired AC current at a different location along the pipe section, each current sensor/coupler providing a respective undesired current sense signal;
providing a plurality of local drivers/detectors, each driver detector of the plurality of drivers/detectors receiving a respective undesired current sense signal from a respective current coupler/sensor, the plurality of local drivers/detectors transmitting the undesired current sense signals to a Multi-in, Multi-out (MIMO) global controller as a first vector;
receiving, by the MIMO global controller, the first vector;
manipulating, by a controller plant in the MIMO global controller, the first vector to provide a second vector that includes a plurality of current compensation signals, each current compensation signal being directed to a respective current coupler/sensor by a respective local driver/detector.

17. The method of claim 16, further comprising:
amplifying the current compensation signals of the second vector by respective driver amplifiers in the plurality of local drivers/sensors, to provide amplified current compensation signals to respective current couplers in the plurality of current sensors/couplers along the pipe section.

18. The method of claim 16, further comprising:
buffering, by respective detectors in respective local drivers/detectors, respective undesired current sense signals to form the first vector that the plurality of local drivers/detectors transmits to the MIMO global controller.

19. The method of claim 16 wherein the MIMO global controller provides overall control of the transmission of current compensation signals to the current couplers of the plurality of current couplers/sensors by the local drivers/detectors of the plurality of local drivers/detectors.

20. The method of claim 16, wherein the MIMO global controller operates in real time to process the first vector and generate the second vector to cancel the undesired AC signal on the pipe section.
